(19) United States
(12) Patent Application Publication
(10) Pub. No.: US 2019/0318004 A1
(43) Pub. Date: Oct. 17, 2019

(54) Intelligent Call Center Agent Assistant

(71) Applicant: Nuance Communications, Inc., Burlington, MA (US)

(72) Inventors: Abhishek Rohatgi, Montreal (CA); Marco Antonio Padron, Longueuil (CA); Flaviu Gelu Negrean, Montreal (CA); Paul Andrew Tepper, Paramus, NJ (US)

(21) Appl. No.: 15/953,376

(22) Filed: Apr. 13, 2018

(51) Int. Cl. G06F 17/30; G06F 7/08

(52) U.S. Cl. CPC G06F 17/30011; G06F 7/08

(57) ABSTRACT

A system for processing user requests provides for recommending products or services for an agent to offer a customer or potential customer. The system classifies a user request by an intent, and presents documentation to assist the agent in handling the request. The system further parses the user request to detect life events experienced by the user that may raise the prospect of the user's interest in other products or services. Based on the detected life events, a number of offers are presented to an agent for recommendation to the user.

### BACKGROUND

Customer-oriented businesses operate in a wide range of industries, including retail sales, banking, and personal services. In order to maintain a relationship with their customers, these businesses often maintain services that allow the customers to interact with a representative of the business. In the past, a business would typically provide a “customer service” telephone number that the customer could call to speak with a representative. With the advent of online communications, businesses have begun providing online “chat” interfaces, accessed by the customer through a smartphone and/or a website, that allow the customer to communicate with a representative by text messages. Businesses have utilized both telephone calls and online messaging to accommodate their customers' preferences.

### SUMMARY

Example embodiments of the present invention include a method of configuring as system for processing requests from a user such as a customer or potential customer. Text from a plurality of documents may be parsed to identify first key words present in the plurality of documents, each of the first key words being associated with a respective user intent. Tags associated with each of the plurality of documents may be generated based on the key words, each of the tags indicating a solution to at least one of the respective user requests. The plurality of documents and tags may be compiled to a solutions database. A table relating second key words to product offers may be generated, each of the second key words indicating a user event. A classifier may be configured to 1) compare a user request against the solutions database to identify a selection of the plurality of documents, and 2) compare the user request against the table to determine a selection of the product offers.

In further embodiments, a transcription engine may be configured to parse the user request to identify words matching the first key words and second key words. The transcription engine may also be configured to parse a dialog between a user and an agent to identify words matching the first key words and second key words. The table may be reconfigured based on an agent selection of the at least one of the product offers. The table may also be reconfigured based on an agent selection of the user event. The tags may be reconfigured based on agent selection of the plurality of documents.

In still further embodiments, the table may be a first table, and a second table may be generated relating a subset of the first key words and second key words to indications of sentiment of the user. The classifier may be configured to compare a word matching the subset against the second table to determine at least one of the indications of sentiment. The tables may be reconfigured based on an agent selection of the indications of sentiment. A user interface may be configured to present, to the agent, a ranked list of the indications of sentiment based on the user request and the table. The user interface may be further configured to present, to the agent, the selection of the plurality of documents and the selection of the product offers, as well as a ranked list of user events based on the user request and the table.

Further embodiments may include a system for processing user requests. A solutions database may be configured to store a plurality of documents and associated tags, each of the tags indicating a solution to at least one of the respective user requests. An intent classifier may be configured to 1) parse a user request to identify first key words, 2) determine a user intent based on the first key words, and 3) retrieve a selection of the plurality of documents based on the user intent and, optionally, the first key words or other language of the user request. An offers database may be configured to store a table relating events and product offers. An event classifier may be configured to 1) parse the user request to identify second key words, 2) compare the second key words against the offers database, and 3) based on the comparison, determine a selection of the product offers. An agent interface may be configured to present, to an agent in communication with a user, the selection of the plurality of documents and the selection of the product offers.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of a system in which embodiments of the present invention may be implemented.

FIG. 2 is a block diagram of a system in a further embodiment.

FIGS. 3A-D is a series of screenshots of a user interface that may be accessed by an agent.

FIG. 4 is a flow diagram illustrating a process of solving a user request in an example embodiment.

FIG. 5 is a flow diagram depicting generation of tagged documents to a solutions database.

FIG. 6 is a flow diagram depicting generation of tagged offers to an offers database.

FIG. 7A is a table relating key words, life events, and product offers.

FIG. 7B is a table relating key words and sentiments.

FIG. 8 illustrates a computer network or similar digital processing environment in which embodiments of the present invention may be implemented.

FIG. 9 is a diagram of an example internal structure of a computer in the computer system of FIG. 8.

### DETAILED DESCRIPTION

A description of example embodiments follows. The teachings of all patents, published applications and references cited herein are incorporated by reference in their entirety.

In some customer contact centers, the agent handling customer requests must manually interpret the customer's question and find a knowledge base entry to help answer the query. Examples of a knowledge base entry could be an article listing troubleshooting questions, or a form for the agent to work with the customer to fill out (e.g., a create new account form). However, the agent at the contact center looking up articles and forms can create lengthy pauses for the customer, which is undesirable. Further, in a video chat, for example, the agent also must divert his attention from the customer to perform the search, which can create an undesirable experience for the customer.

In an example embodiment, a contact center virtual assistant automatically interprets the input (e.g., voice call, text based chat, video chat, or email) of a user, who may be a customer or a potential customer. The virtual assistant, based on its interpretation, performs a search of knowledge bases (e.g., databases in a memory or hard disk) and presents the agent with one or more articles or forms that are likely to assist in the user interaction. The virtual assistant then presents either the article or form to the agent or a list of articles or forms for the agent from which to choose. In this manner, the agent can forgo performing a search because the system has automatically done so. The virtual assistant can also interpret the user's input, as well as a dialog with the agent, to determine the user's sentiment, as well as whether the user is experiencing any life events that would raise the opportunity for any other products or services. Based on the identified life events and sentiments, the virtual assistant can also present the agent with information on products or services, to which the agent can refer when upselling the user for additional products or services. As a result, the virtual assistant 1) increases agent efficiency, 2) reduces agent training required for effective upselling, 3) reduces the time required to resolve a user inquiry, and 4) increases user satisfaction with the contact center experience.

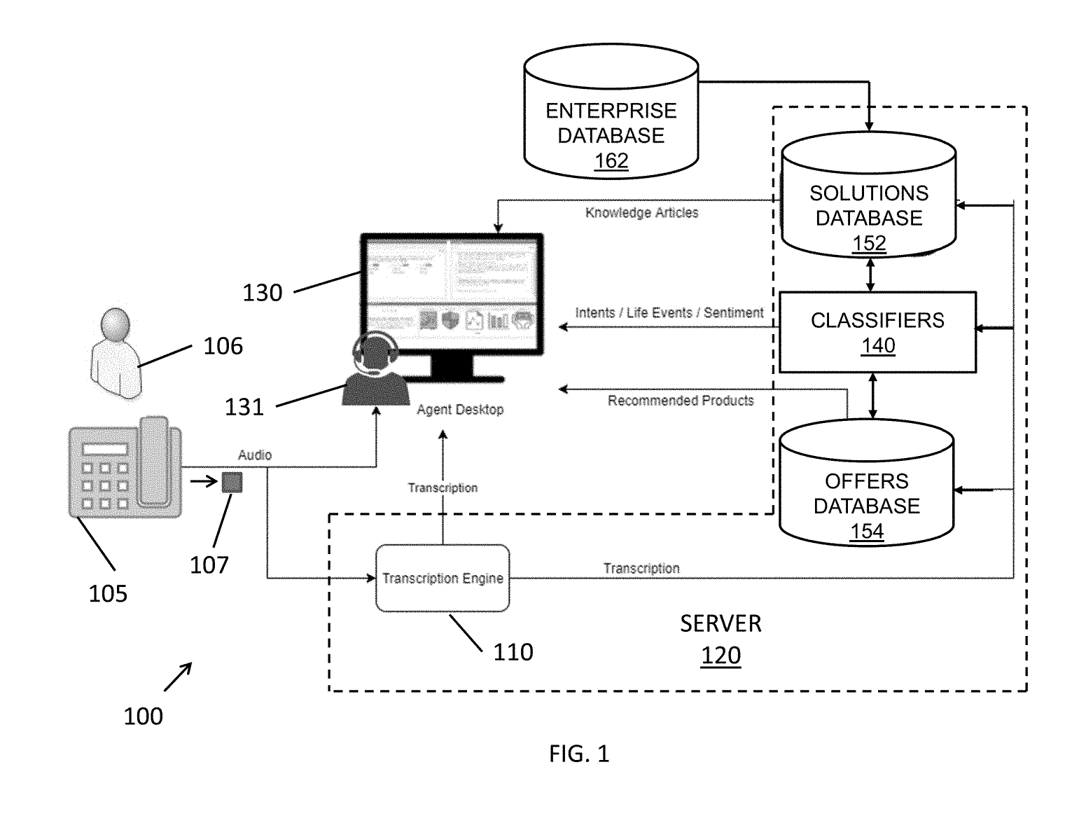

FIG. 1 is a block diagram of a system 100 in which embodiments of the present invention may be implemented. The system 100 may encompass a network 108 (e.g., a customer service cloud operated by an enterprise, which may be communicatively coupled with a voice-over-IP (VoIP) network, telephone network, and/or the Internet) whereby a user 106 (e.g., a customer or potential customer) engages with a user service of the enterprise using a user interface 105 (e.g., a telephone, a user service webpage, or a mobile device). For example, the user 106 may be a caller to a customer service center. An agent 131 communicates with the user 106 via the network 108 to resolve a user request 107. A server 120 is configured to receive those communications (e.g., the user request and/or a dialog between the user 106 and the agent 131, where the user 106 conveys his/her request in conversation with the agent 131) via the network 108 and communicate with the agent 131 via the agent's terminal 130 to assist in resolving the user request 107. For example, the agent 131 may be located in a user service call center for attending to requests made by users of the enterprise, including the user 106. The server 120 may be located at the call center, or may be remote from the call center. For example, the server 120 may be embodied as a cloud computing service accessible to both the agent 131 via the desktop terminal 130 and by the user 106 via the user interface 105.

When the user 106 wishes to engage with the user service provided by the enterprise (e.g., the user 106 has a question about his/her account, wishes to update his/her account, or submits an order for a product or service from the enterprise), the user 106 submits a request 107 through the interface 105, and the network 108 routes the request 107 to the server 120. The request 107 may be submitted by the user 106 may be embodied in a text message typed by the user, an utterance spoken by the user 106 in a telephone call or other voice interface, a menu selection, or a comparable medium.

The server 120 may be configured generally to process a user request in the following manner. First, a transcription engine 110 receives the request 107 and/or a dialog between the user 106 and the agent 131, and generates a transcription of the request and/or dialog. The transcription engine 110 may then forward this transcription to the agent desktop 130 where it may be displayed to the agent 131, and forwards the transcription to classifiers 140. The classifiers 140 operate to identify key words from the request 107 or dialog in order to classify the request 107 according to multiple classifications. For example, the classifiers 140 may classify the request by matching it to one of a number of given intents (e.g., “check balance,” “issue travel notification,” or “update contact information”). If the request 107 can be classified to an intent, then the server 120 may access a solutions database 152 to retrieve articles, instructions, forms, templates, and/or other materials related to solving that request 107. Those materials may be compiled from a larger enterprise database 162. The classifiers 140 (or the solutions database 152) may then forward the materials to the agent desktop 130 where it is displayed for access by the agent 131.

The classifiers 140 may also classify the request 107 to determine additional information about the user 106. For example, the user 106, when making the request 107, may mention a notable event in the user's life, such as a marriage, a new business, or a newborn. Such events may give rise to a need or desire for other products or services that are offered by the enterprise. In order to assist the agent 131 in offering/upselling those products/services to the user 106, the classifiers 140 may access an offers database 154 to retrieve one or more offers for products/services based on the classified life event(s). The classifiers 140 may also estimate the user's sentiment based the life event(s) and/or keywords from the request 107 and/or dialog. By gauging the user's sentiment, the classifiers 140 can also provide a recommendation to the agent 131 regarding whether the user is receptive to an offer for additional products or services. The classifiers 140 may also forward the classified intent, life event(s) and sentiment to the agent desktop 130 for reference by the agent 131.

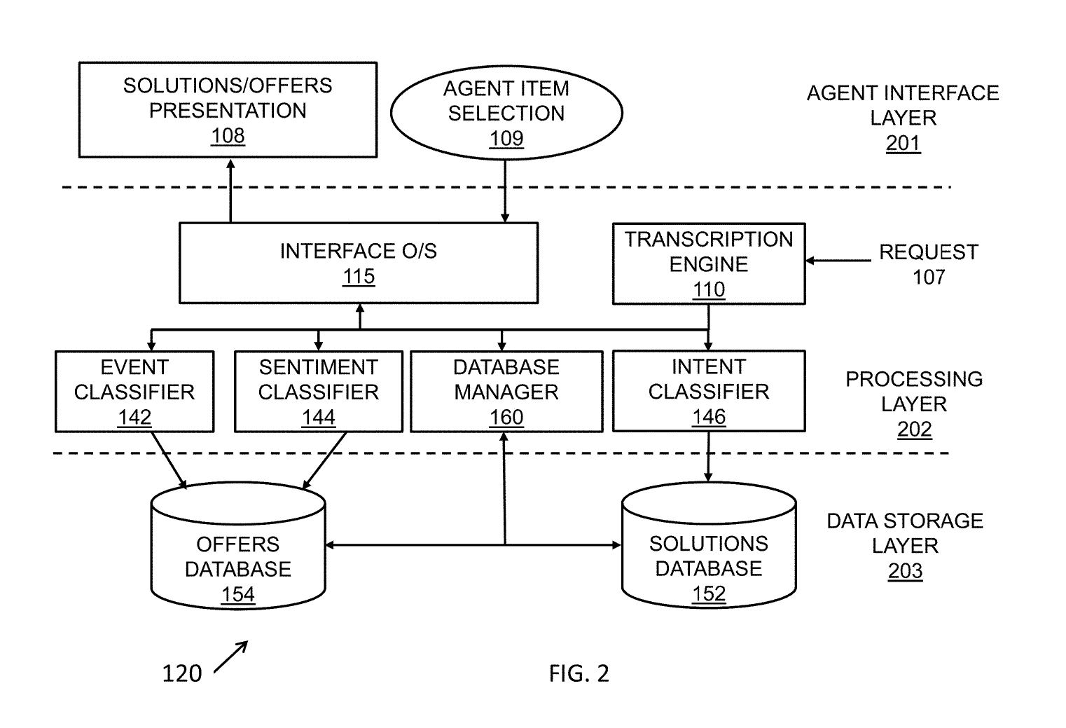

FIG. 2 is a block diagram of the server 120 in further detail. The server 120 includes an agent interface layer 201 for interacting with an agent, a processing layer 202, and a data storage layer 203. With reference to FIG. 1, the processing layer 202 may include an interface operating system (OS) 115 (e.g., a workstation OS), which interacts with the agent 131 at the agent desktop 130. In particular, the interface OS 115 provides for presentation of solutions and offers 108, and receives agent input 109 including selection of displayed items (e.g., classifier results, solutions materials, and/or offers). The classifiers 140 shown in FIG. 1 may include an event classifier 142, a sentiment classifier 144, and an intent classifier 146. The intent classifier may classify an intent of the user request 107 for the retrieval of appropriate material from the solutions database 152. The event classifier 142 may identify life events of the user 106 for the retrieval of appropriate offers from the offers database 154. Further, the sentiment classifier 144 may estimate the user's sentiment in order to inform the agent regarding a decision whether to present those offers to the user 106.

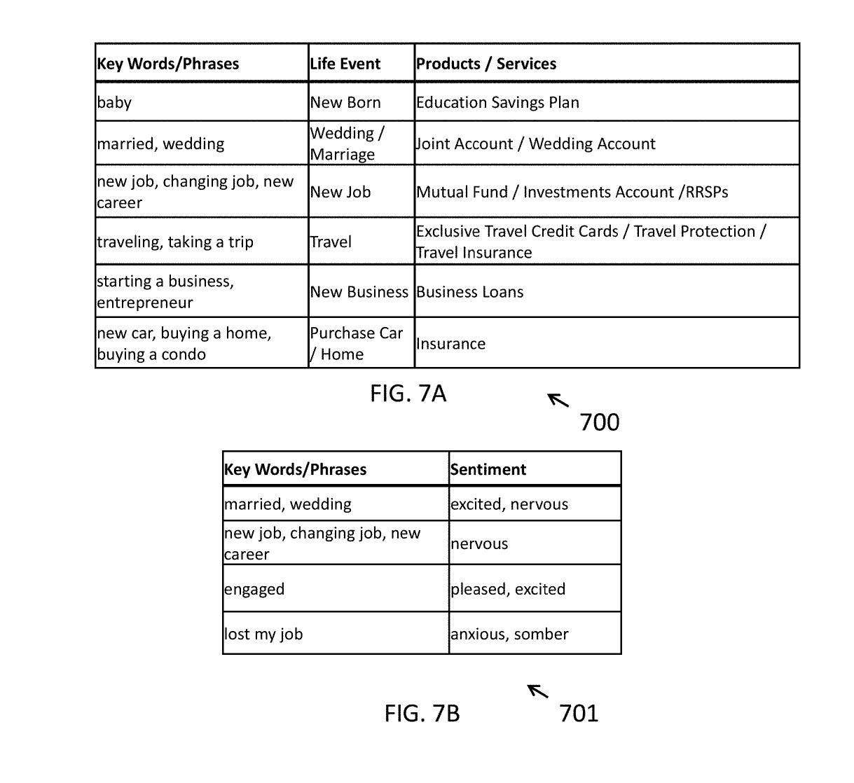

A database manager 160 may operate to configure the solutions database 152 and/or offers database 154, for example by populating and maintaining entries within each database. In an example embodiment, the database manager 160 may search documents in an external database (e.g., enterprise database 162) for documents relevant for resolving a range of user requests. The database manager 160 may generate tags associated with each of the documents based a collection of key words of prospective user requests. The documents may then be tagged according to relevant key words, relevant intent, and/or relevant solutions, and the tagged documents may be compiled to the solutions database 152. The database manager 160 may also search documents regarding product/service offers, tag those documents according to relevant offers, user life events and/or sentiments, and compile those tagged documents to the offers database 154. The database manager 160 may perform such compiling and/or tagging in accordance with a table relating key words, solutions and/or offers, as described below with reference to FIGS. 7A-B. The database manager may also respond to input by the agent 131 (e.g., agent item selection 109) to update the databases 152, 154 accordingly.

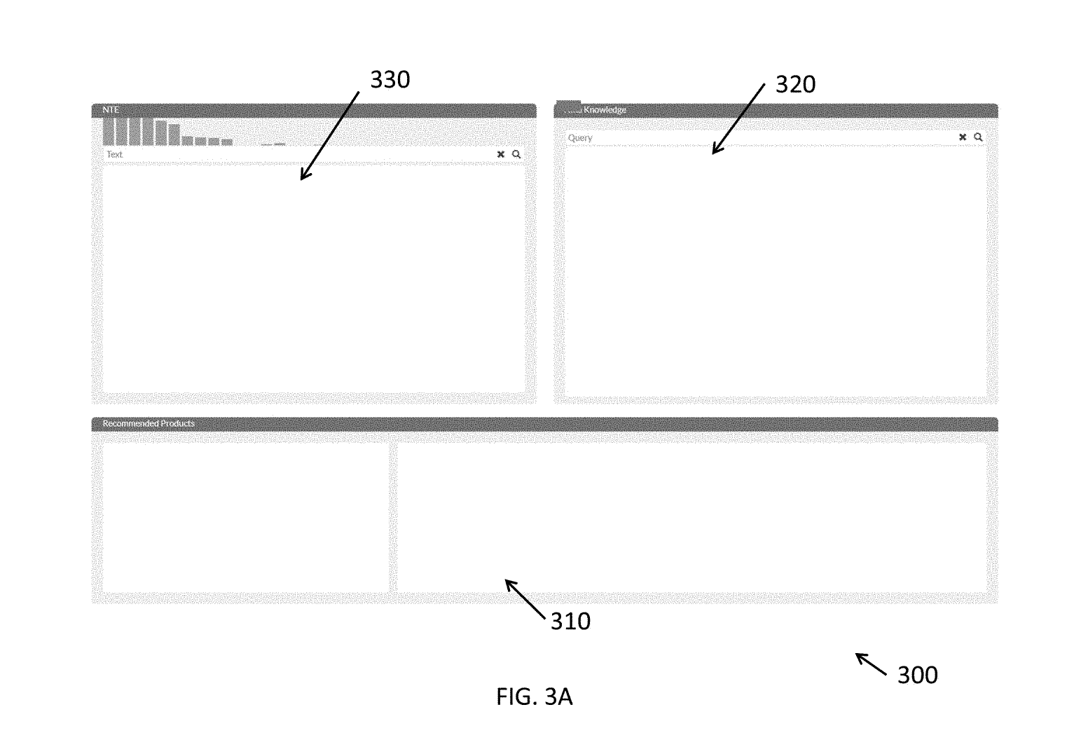

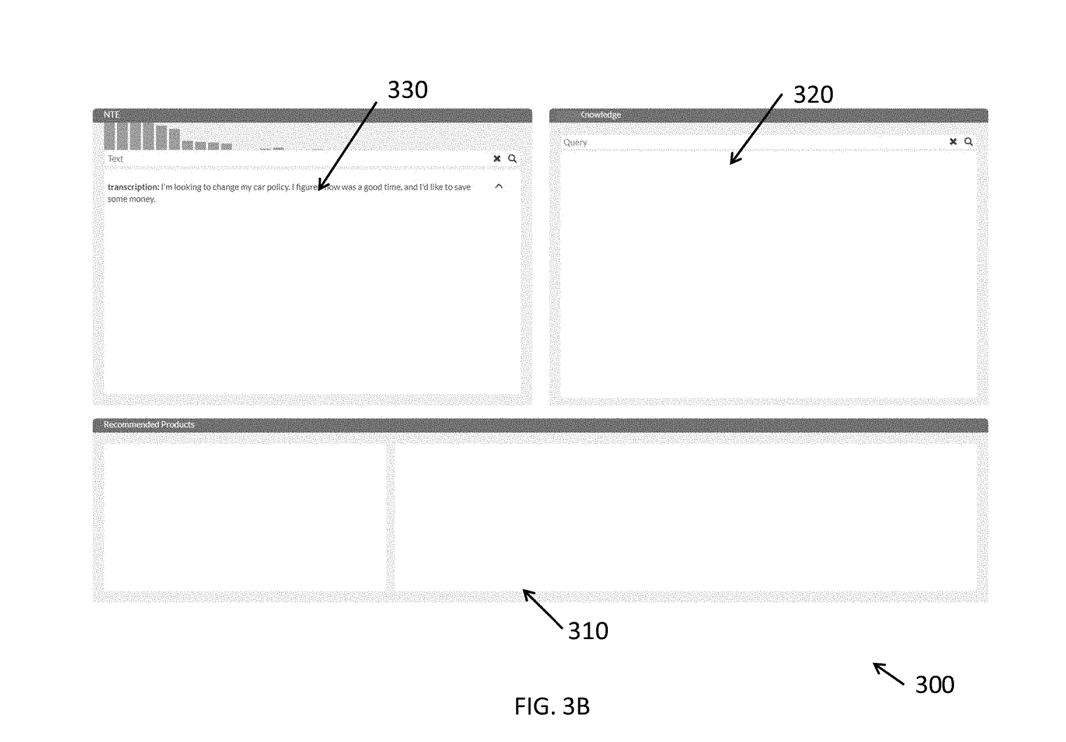

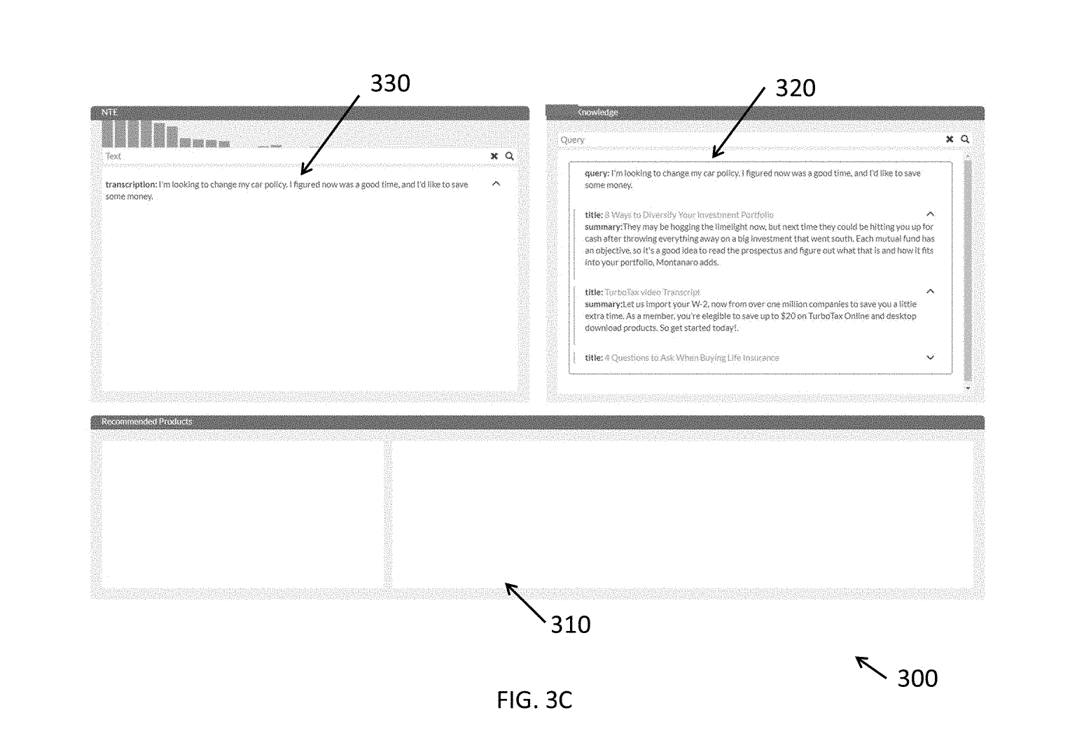

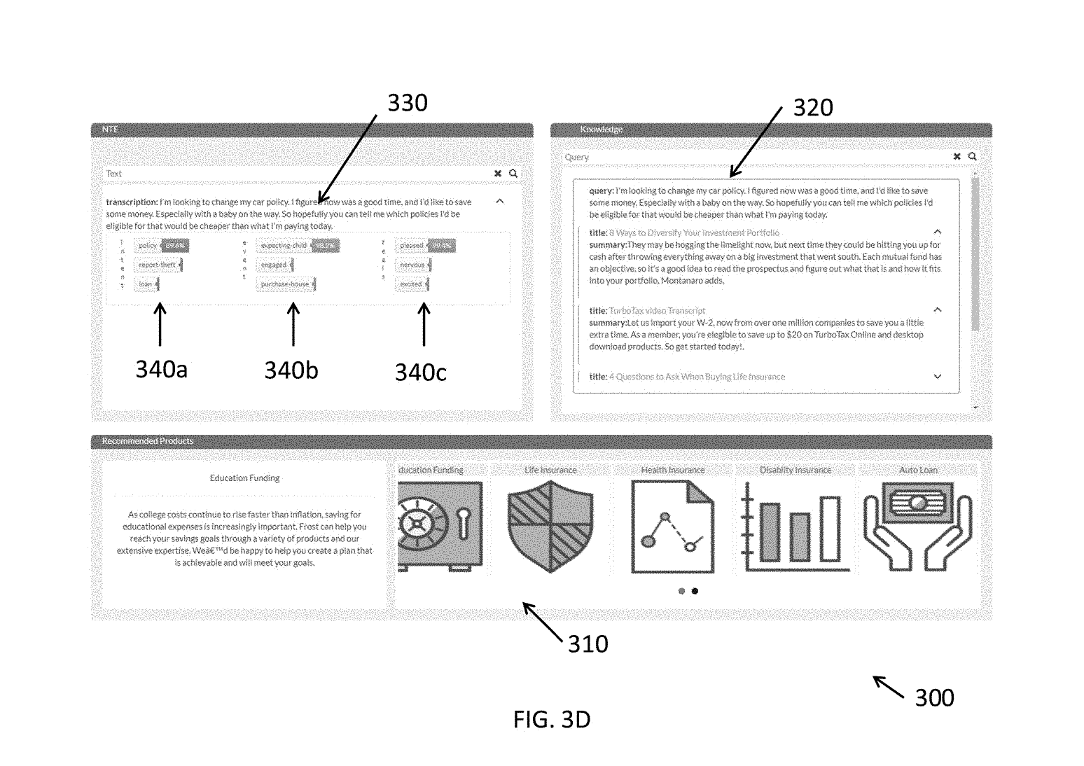

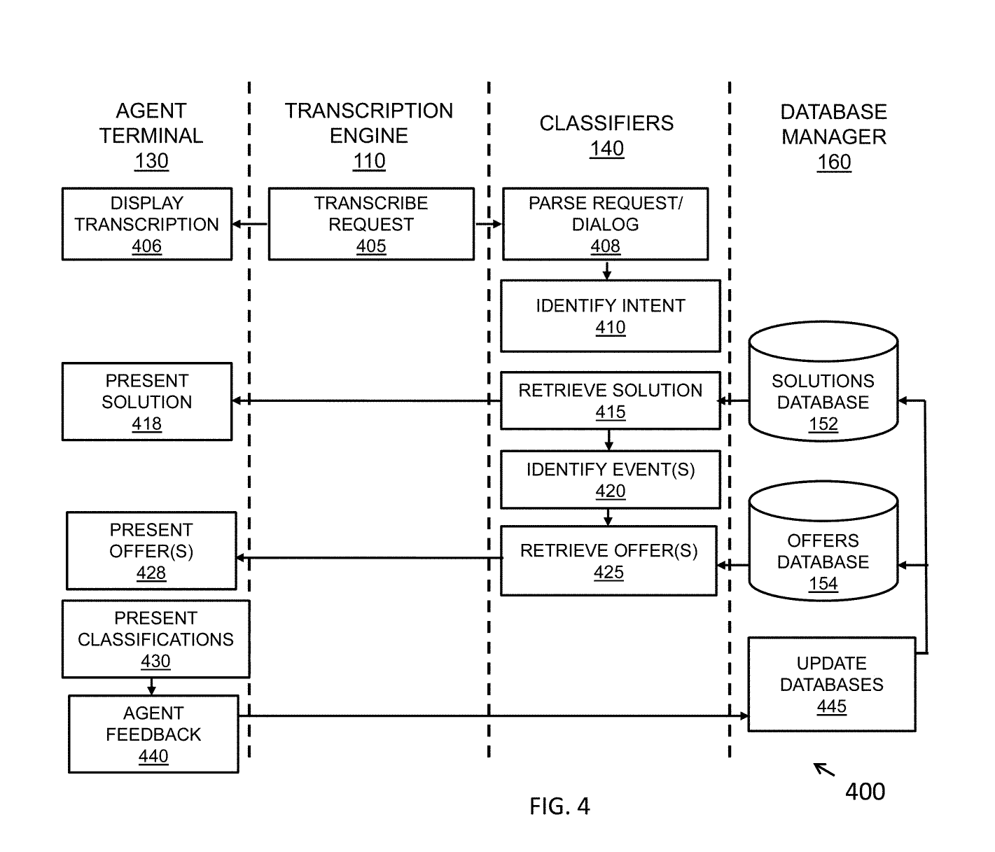

FIGS. 3A-D is a series of screenshots of a user interface 300 that may be accessed by an agent. For example, the user interface 300 may be displayed at the agent desktop 130 shown in FIG. 1. As shown in FIG. 3A, the user interface 300 includes a transcription pane 330, a solutions pane 320, and an offers pane 310. FIGS. 3B-D illustrate the user interface 300 as it becomes populated with entries during an operation of handling a user request. Those entries are described in further detail below with reference to FIG. 4.

FIG. 4 is a flow diagram illustrating a process 400 of solving a user request in an example embodiment. With reference to FIGS. 1 and 2, the transcription engine 110 may receive a user request 107 and transcribe it to generate a transcription of the request (405). For example, the request 107 may be an audio recording of an utterance by the user 106, which the transcription engine 110 transcribes using voice recognition and natural language processing techniques. The transcription engine 110 may also transcribe a dialog between the user 106 and agent 131, which may include the request 107. The agent terminal 130 may then receive the transcription of the request 107 or dialog and display the transcription to the agent 131 (406). At this stage, the agent's user interface may resemble the user interface 300 shown in FIG. 3B, which includes a transcription of a request 107 presented in the transcription pane 330. Alternatively, if the user 106 issues the request via other means that do not require transcription (e.g., a written message, or selection at a user interface), or if the dialog is conducted through written means (e.g., a chat window) then the transcription engine 110 may be bypassed, and text of the request 107 and/or dialog may be displayed at the agent terminal 131 directly.

The classifiers 140 receive the transcription and parse it to identify key words of the request and/or dialog. Those key words may be grouped into two or more sets depending on their use by different classifiers (e.g., classifiers 142, 144, 146), and each key word may be included in more than one set. The intent classifier 146 may utilize a first set of key words to identify the intent of the request (e.g., a question about the user's account, a request to update his/her account, an order for a product or service from the enterprise) (410). Once the intent is identified, the intent classifier 146 (or, alternatively, the database manager 160 or other controller) may search the solutions database 152 for documents relevant to solving the user request (e.g., articles, instructions, forms, templates). Such documents may be identified based on a one or more tags assigned to each document in the database 152, where such tags may indicate a corresponding intent, key word(s), or both. The classifier 146 (or a database controller) may then retrieve the identified documents from the database 152 (415), and forward them to the agent terminal 130 for presentation to the agent 131 (418). At this stage, the agent's user interface may resemble the user interface 300 shown in FIG. 3C, which includes a presentation of the solutions documents in the solutions pane 320. Example embodiments may implement approaches for identifying an intent and retrieving relevant documents for assisting an agent to resolve the request as described in US Patent Applications 2016/0179934A1, 2016/0180217A1, and 2017/0032027A1, the entire teachings of which are incorporated herein by reference.

The event classifier 142 may utilize a second set of key words to identify any notable events associated with the user 106 (e.g., marriage, a new business, a new job, a newborn) (420). Once the event(s) is identified, the event classifier 142 (or the database manager 160 or other controller) may search the offers database 154 for information regarding offers for products or services that may be of interest to the user in view of the identified events. Such offers may be identified based on a one or more tags assigned to each offer in the database 152, where such tags may indicate a corresponding event, key word(s), or both. Alternatively, the offers may be identified based on a table relating the offers, events and/or keywords (see, e.g., the table of FIG. 7A, described below). The classifier 142 (or a database controller) may then retrieve the identified offers from the database 154 (420) and forward them to the agent terminal 130 for presentation to the agent 131 (428). At this stage, the agent's user interface may resemble the user interface 300 shown in FIG. 3D, which includes a presentation of the offers in the offers pane 310.

In parallel with identifying the events and presenting offers, the sentiment classifier 144 may utilize a third set of key words (which may be identical to, or share common words with, the first or second sets of key words) to estimate the user's sentiment. This sentiment may be utilized to inform a recommendation regarding the offered products or services. For example, if the sentiment classifier 144 detects a positive sentiments (e.g., pleased or excited), indicating greater receptiveness to an upsell, then the agent terminal 130 may present a stronger recommendation to offer particular products/services, or may present a larger number of products/services to offer. Alternatively, if the sentiment classifier detects a negative sentiment, then the agent terminal 130 may present a recommendation against an upsell, or may present an offer for a product/service relating to a life event that may be associated with the negative sentiment. For example, if the sentiment classifier 144 detects a negative sentiment, and the event classifier identifies a recent job loss by the user, then the terminal 130 may display a targeted menu of offers that may assist the user in managing his/her unemployment. The sentiments may be identified based on a table relating the sentiments and keywords (see, e.g., the table of FIG. 7B, described below). In further embodiments, the sentiment classifier may estimate the user's sentiment based on a detected tone in the user's utterances (e.g, voice patterns that indicate stress or excitement).

The agent terminal 130 may also display the direct results of one or more of the classifiers 142, 144, 146 (430). For example, as shown in FIG. 3D, the transcription pane 330 includes lists 340a-c. The lists 340a-c may be ordered lists that display a “best guess” estimate resulting from each classification (along with a percentage indicating certainty of the estimate), as well as one or more alternative choices. For example, the list 340a indicates the results of the intent classification, with “policy” (indicating a request for a change in a policy product, such as a car insurance policy) being the top estimate with 89.6% certainty, and “report theft” and “loan” being alternative choices. Likewise, the list 340b indicates the results of the event classification, and the list 340c indicates the results of the sentiment classification. In order to improve future classification, presentations and recommendations, the database manager 160 may accept feedback from the agent 131 (440). This feedback may include manual selection of items from the lists 340a-c (indicating that the agent confirms the results or identifies a better choice from the lists), as well as the agent's selection of specific articles from the solutions page 320 and specific offers from the offers pane 310. Based on this feedback, the database manager may update the databases 152, 154 accordingly (445). For example, the database manager 160 may edit the tags of the documents in the solutions database 152, edit the tags of the offers in the offers database 154, edit table relating key words, intents, offers and/or sentiments, or may retrain an artificial neural network (ANN) operating as one or more of the classifiers 142, 144, 146. As a result, the server 120 may interpret future user requests with greater accuracy, and recommend products or services to which the user is more likely to respond positively.

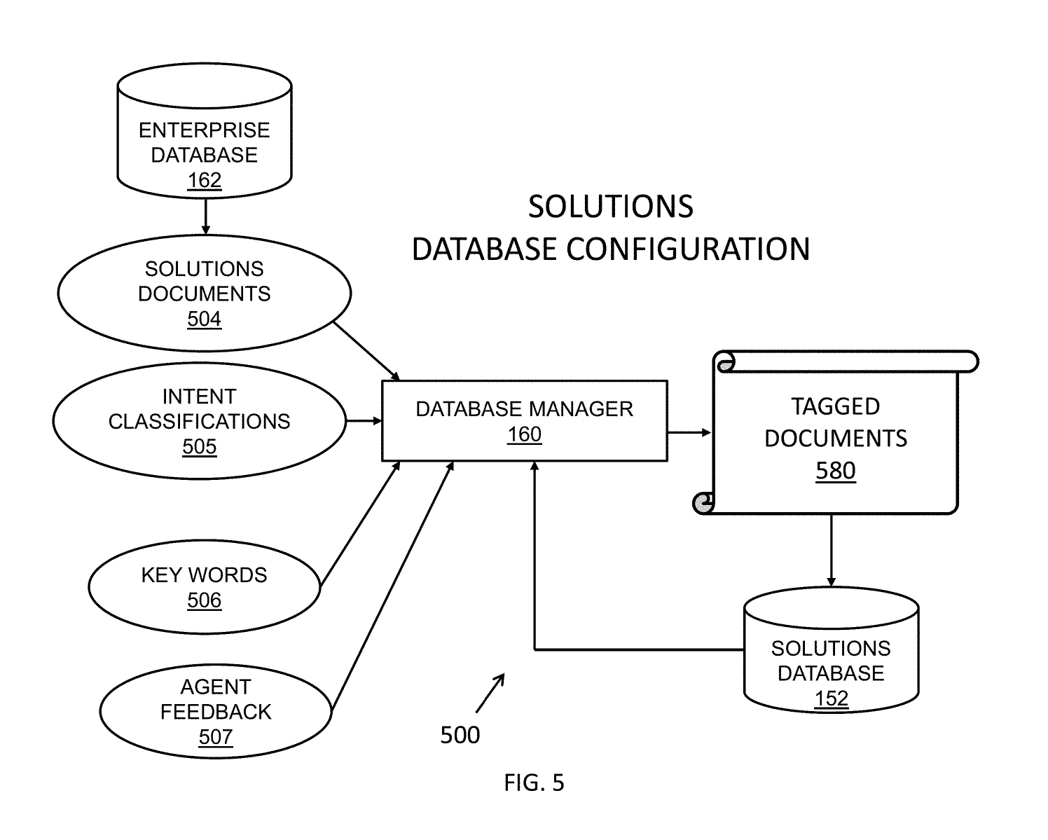

FIG. 5 is a flow diagram depicting a process 500 of configuring a solutions database 152 in an example embodiment. Such configuration can include populating the database 152 with tagged documents 580 and/or modifying those tagged documents during an update. With reference to FIGS. 1 and 2, the database manager 160 may collect data from several different sources to configure the solutions database 152. Those sources may include solutions documents 504 (e.g., informative articles, forms, templates) retrieved from an enterprise information database 162, intent classifications 505 (e.g., categories of user requests or solutions to user requests), key words 506 relating to those intent classifications 505, agent feedback 507 (e.g., agent selection of presented solutions in response to prior user requests), and prior entries from the solutions database 152. The intent classifications 505 and key words 506 may be related to one another via a table.

Based on a combination of some or all of the above sources, the database manager 160 generates and/or updates the tagged documents 580 for storage at the solutions database 152. For example, the intent classifications 505 and key words 506 may be compiled in a table that is programmed by a user (e.g., an agent or enterprise manager), and the database manager 160 may search the solutions documents 504 to identify matching key words. Based on such identification, the database manager may tag those documents 504 with corresponding tags identifying one or more intent classifications 505 and/or key words 506, resulting in the tagged documents 580. Alternatively, instead of compiling tagged documents, the database manager 160 may configure the solutions database 152 for retrieval of documents via a table, an index, pointers, or another relational structure. The process 500 and/or the solutions database 152 may incorporate one or more features as described in US Patent Applications 2016/0179934A1, 2016/0180217A1, and 2017/0032027A1, the entire teachings of which are incorporated herein by reference.

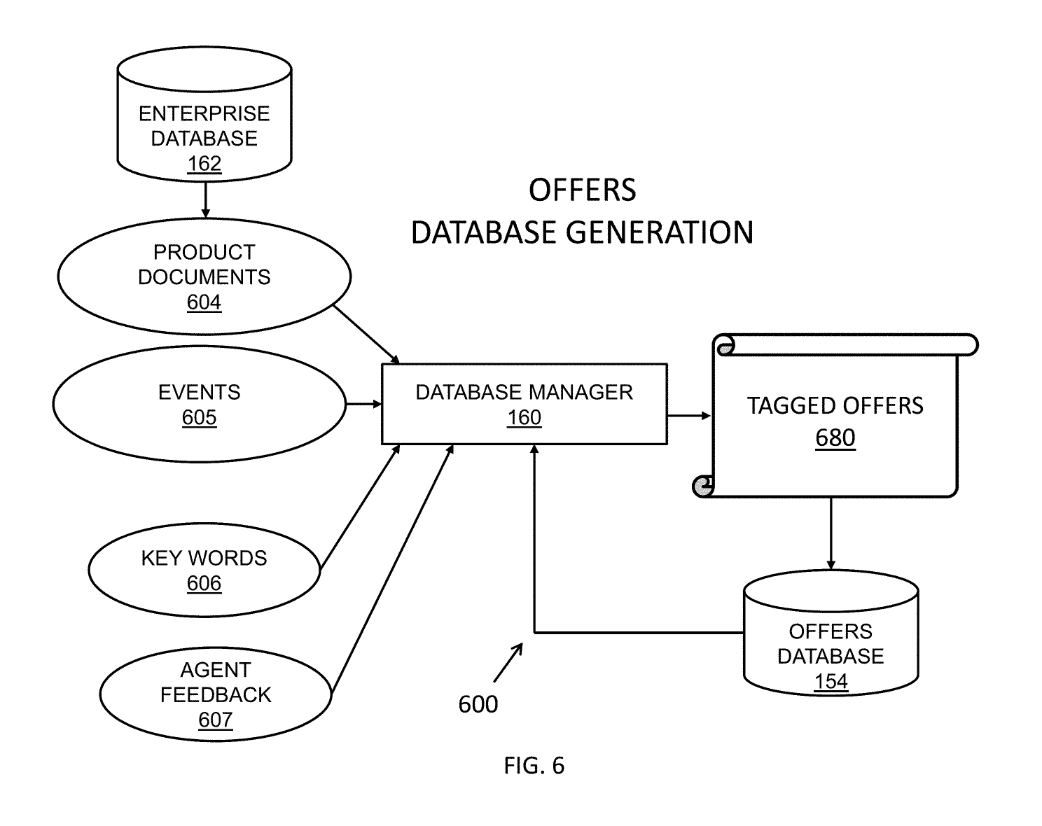

FIG. 6 is a flow diagram depicting a process 600 of configuring an offers database 154 in an example embodiment. Such configuration can include populating the database 154 with tagged offers 680 and/or modifying those tagged offers during an update. With reference to FIGS. 1 and 2, the database manager 160 may collect data from several different sources to configure the offers database 154. Those sources may include product documents 604 (e.g., informative articles) retrieved from an enterprise information database 162, event classifications 605 (e.g., categories of life events associated with a user), key words 606 relating to those event classifications 605, agent feedback 607 (e.g., agent selection of presented offers in response to prior user requests), and prior entries from the offers database 152. The event classifications 605 and key words 606 may be related to one another via a table, such as the table described below with reference to FIG. 7A.

Based on a combination of some or all of the above sources, the database manager 160 generates and/or updates the tagged offers 680 for storage at the offers database 154. For example, the event classifications 605 and key words 606 may be compiled in a table that is programmed by a user (e.g., an agent or enterprise manager), and the database manager 160 may search the product documents 604 to identify matching key words. Based on such identification, the database manager 160 may tag those offers 604 with corresponding tags identifying one or more event classifications 605 and/or key words 606, resulting in the tagged documents 680. Alternatively, the database manager may configure the offers database 154 to include a table, such as the table of FIG. 7A described below, relating key words 606, event classifications 605, and corresponding product offers, where the corresponding product offers may include a pointer or link to further information regarding the respective offer or product/service. As a result, the event classifier 142 may reference the table, based on the key words of a user request, to identify one or more product offers for display at the agent interface 130. The sentiment classifier 144, as described above, may reference the same or a separate table (e.g., the table of FIG. 7B, described below) to further inform the recommendation of product/service offers.

FIG. 7A is a table 701 relating key words, life events, and product offers. The left column stores entries for key words/phrases that may be spoken or stated by the user when making a request. The center column stores entries for corresponding life events that may be suggested by the key words/phrases. The right column stores entries for products/services that may be appropriate to offer a user experiencing the corresponding life event. As described above, the event classifier 142 may utilize the table 700, along with key words of a user request, to identify one or more product offers for display at the agent interface 130.

FIG. 7B is a table 701 relating key words and sentiments. The left column stores entries for key words/phrases that may be spoken or stated by the user when making a request. The right column stores entries for sentiments that are likely to be associated with a user who states those key words. As described above, the sentiment classifier 144 may reference the table 701 to inform the recommendation of products/service offers. In further embodiments, the tables 700, 701 may be combined into a single table that is accessed by both the event classifier 142 and the sentiment classifier 144.

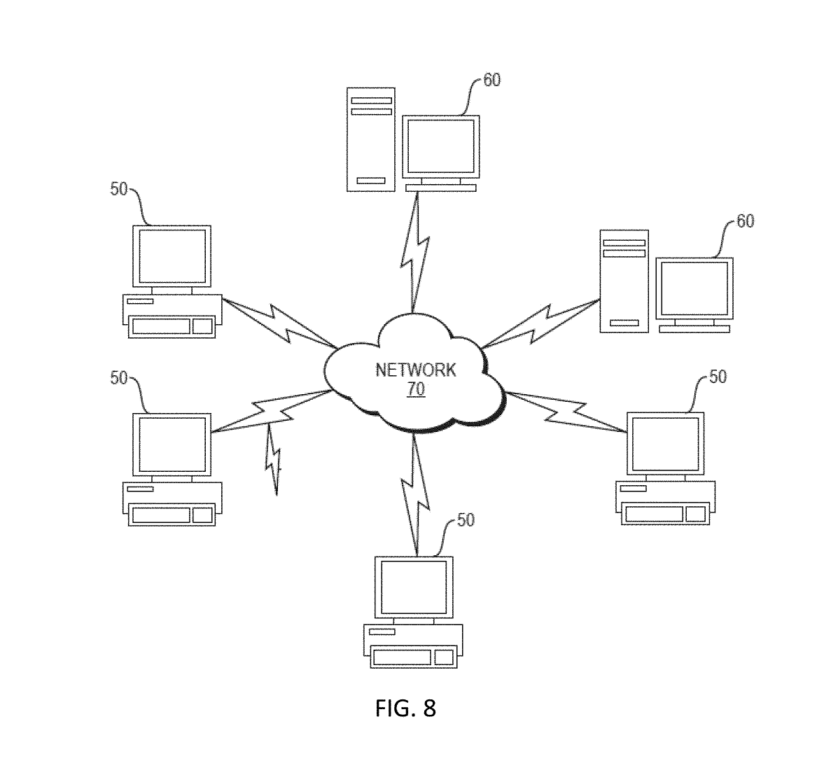

FIG. 8 illustrates a computer network or similar digital processing environment in which example embodiments may be implemented. Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

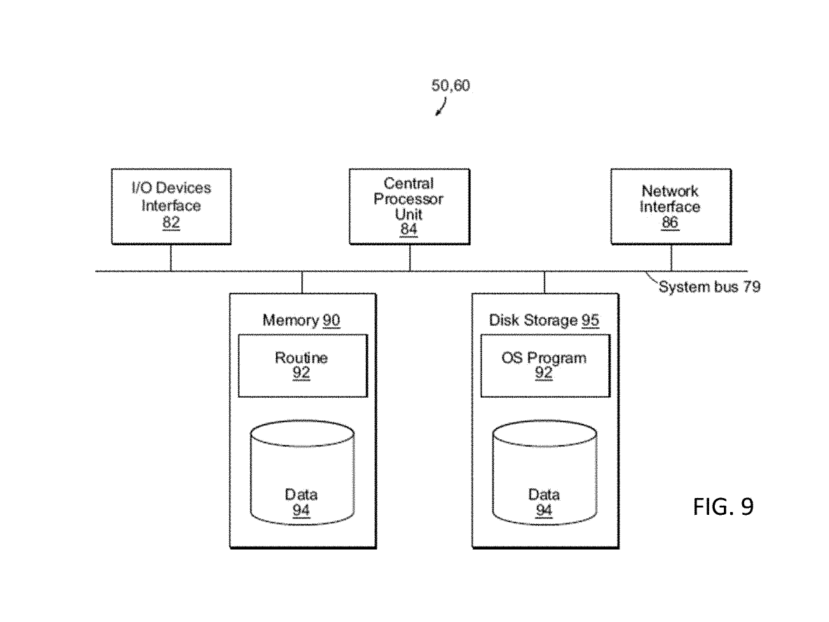

Embodiments described above, with reference to FIGS. 1-7, may be implemented in the computer network. For example, the server 120 may be embodied by one or more of the server computers 60, and may receive communications from a client 106 operating a client device 105, as well as communicate with the agent 131 via the agent desktop 130. An example server 60 or device 50 is described in further detail below with reference to FIG. 9.

FIG. 9 is a diagram of the internal structure of a computer system 50 (e.g., client processor/device 50 or server computers 60) in which example embodiments of the invention may be implemented. The computer system 50 includes system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50. Network interface 86 allows the computer to connect to various other devices attached to a network. Memory 90 provides volatile storage for computer software instructions 92 and data 94 used to implement an automated management system using a model based architecture assembly (e.g., multilayered mathematical model 12 and monitor 42, interpreter 44, rules engine 38 and supporting code 32, 34, 36, business ephemeris 22, 24, 26 and other features code detailed above in FIGS. 1-6), as well as other embodiments of the present invention (detailed below). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

While example embodiments have been particularly shown and described, it will be understood by those skilled in the art that various changes in form and details may be made therein without departing from the scope of the embodiments encompassed by the appended claims.

What is claimed is:

1. A method of configuring a system for processing user requests; comprising:
parsing text of a plurality of documents to identify first key words present in the plurality of documents, each of the first key words being associated with a respective user intent;
generating tags associated with each of the plurality of documents based on the key words, each of the tags indicating a solution to at least one of the respective user requests;
compiling the plurality of documents and tags to a solutions database;
generating a table relating second key words to product offers, each of the second key words indicating a user event;
configuring a classifier to 1) compare a user request against the solutions database to identify a selection of the plurality of documents, and 2) compare the user request against the table to determine a selection of the product offers.

2. The method of claim 1, further comprising configuring a transcription engine to parse the user request to identify words matching the first key words and second key words.

3. The method of claim 1, further comprising configuring a transcription engine to parse a dialog between a user and an agent to identify words matching the first key words and second key words.

4. The method of claim 1, further comprising reconfiguring the table based on an agent selection of the at least one of the product offers.

5. The method of claim 1, further comprising reconfiguring the table based on an agent selection of the user event.

6. The method of claim 1, further comprising reconfiguring the tags based on agent selection of the plurality of documents.

7. The method of claim 1, wherein the table is a first table, and further comprising:
generating a second table relating a subset of the first key words and second key words to indications of sentiment of the user; and
configuring the classifier to compare a word matching the subset against the second table to determine at least one of the indications of sentiment.

8. The method of claim 7, further comprising reconfiguring the table based on an agent selection of the indications of sentiment.

9. The method of claim 7, further comprising configuring a user interface to present, to the agent, a ranked list of the indications of sentiment based on the user request and the table.

10. The method of claim 1, further comprising configuring a user interface to present, to the agent, the selection of the plurality of documents and the selection of the product offers.

11. The method of claim 10, further comprising configuring the user interface to present, to the agent, a ranked list of user events based on the user request and the table.

12. A system for processing user requests; comprising:
a solutions database configured to store a plurality of documents and associated tags, each of the tags indicating a solution to at least one of the respective user requests;
an intent classifier configured to 1) parse a user request to identify first key words, 2) determine a user intent based on the first key words, and 3) retrieve a selection of the plurality of documents based on at least one of the first key words and the user intent;
an offers database storing a table relating events and product offers;
an event classifier configured to 1) parse the user request to identify second key words, 2) compare the second key words against the offers database, and 3) based on the comparison, determine a selection of the product offers; and
an agent interface configured to present, to an agent in communication with a user, the selection of the plurality of documents and the selection of the product offers.

13. The system of claim 12, further comprising a transcription engine configured generate a transcription of the user request.

14. The system of claim 13, wherein the transcription engine is further configured to parse a dialog between a user and an agent to identify words matching the first key words and second key words.

15. The system of claim 12, further comprising a database manager configured to reconfigure the table based on an agent selection of the at least one of the product offers.

16. The system of claim 12, further comprising a database manager configured to reconfigure the table based on an agent selection of the user event.

17. The system of claim 12, further comprising a database manager configured to reconfigure the tags based on agent selection of the plurality of documents.

18. The system of claim 12, wherein the table is a first table, and further comprising a database manager configured to:
generate a second table relating a subset of the first key words and second key words to indications of sentiment of the user; and
configure a sentiment classifier to compare a word matching the subset against the second table to determine at least one of the indications of sentiment.

19. The system of claim 18, wherein the database manager is further configured to reconfigure the table based on an agent selection of the indications of sentiment.

20. A computer-readable medium storing instructions that, when executed by a computer, cause the computer to:
parse text of a plurality of documents to identify first key words present in the plurality of documents, each of the first key words being associated with a respective user intent;
generate tags associated with each of the plurality of documents based on the key words, each of the tags indicating a solution to at least one of the respective user requests;
compile the plurality of documents and tags to a solutions database;
generate a table relating second key words to product offers, each of the second key words indicating a user event;
configure a classifier to 1) compare a user request against the solutions database to identify a selection of the plurality of documents, and 2) compare the user request against the table to determine a selection of the product offers.
